(19) United States
(12) Patent Application Publication
(10) Pub. No.: US 2006/0254660 A1
(43) Pub. Date: Nov. 16, 2006

(54) Method and apparatus for temporarily stopping the flow in a live fluid carrying pipe

(76) Inventor: Russell L. McIlwain, Oak Brook, IL (US)

Correspondence Address: Russell L. McIlwain, 3009 Grant Street, Oak Brook, IL, 60523, US

(21) Appl. No.: 11/126,812

(22) Filed: May 12, 2005

(51) Int. Cl. F16L 55/10

(52) U.S. Cl. 138/89

(57) ABSTRACT

A method and apparatus for temporarily stopping the flow of a fluid issuing from a live conduit includes a plug device which can be manually inserted into the flowing pipe to stop the flow of fluid temporarily while the pipe is repaired, for example. The plug is designed to remain in the pipe and dissolve within a predetermined time under contact with the particular fluid in the live pipe such that, in time, normal flow of pipe fluid is resumed.

### BACKGROUND OF THE INVENTION

1. Field of the Invention

The present invention relates generally to a method and apparatus for temporarily stopping the flow in a live fluid carrying pipe and, more particularly, to a plug which can be installed in a damaged pipe wherein the plug is made of a material which dissolves, in time, and temporarily stops the flow of fluid issuing from the pipe while a repair of the pipe is made.

2. Description of the Related Art

Pipes that carry fluid under pressure are installed in a variety of industrial and building construction applications. One such application that is in widespread use, for example, is a water service line connecting a residence or other building to a water main buried in an adjacent street or other right-of-way. Typically, these lines are fabricated from copper, plastic or lead, although lead water pipes have in recent years fallen out of favor because of the potential water contamination problems they pose. These lines, such as those used for serving residences, for example, generally have a standard internal diameter, such as ¾ inch, 1 inch or even 1½ inch, and are buried in the ground to a depth sufficient to protect and conceal them and to prevent their freezing in cold ambient temperature conditions.

It is not uncommon in the underground construction business for a buried water service line to be damaged during construction or repair of other underground utilities, such as sanitary sewers, storm sewers, natural gas mains, direct-buried electrical cables or even water mains themselves. The kind of digging equipment used in underground construction often involves large excavators or backhoes which are not sensitive enough for the operator to feel when he or she has struck a buried water line. While efforts are often made in advance of a particular underground construction project to locate and mark existing buried utilities, these efforts are not always successful. Accordingly, it is a frequent occurrence that water service lines are damaged or completely severed during underground construction.

When a water service line is damaged or severed the amount of water that can issue from even a small diameter line is quite significant given that these lines are typically under 50 to 70 psi pressure. It is, therefore, desirable to fix the affected line or at least temporarily stop its flow so that normal construction activities can resume. It is often not possible or practical to shut valves off at the water main or damaged service line to stop the flow of water. More commonly, particularly where a malleable pipe is involved, such as soft copper, a construction worker can simply crimp the pipe with a hammer, for example, to stop the flow. Of course, that step is only a temporary fix and the pipe still needs to be properly reconnected, often quickly, so that normal construction can resume.

Several methods have been developed for repairing damaged water service lines, particularly those made of soft copper. One such method involves the use of a hand-held crimping tool which can crimp the line closed then reform the crimped portion to open the line after a new piece of copper pipe is spliced in and the repair is completed, such as with compression couplings. A problem with the use of such a crimping tool is that the pipe cannot be restored to a truly round shape and thus a restriction in the pipe is created. In addition, the stressing of the pipe from crimping and then reopening it causes an area of weakness in the wall of the pipe because of the mechanical working of the copper.

Another method of repairing a damaged water service line involves first crimping the line closed and then freezing the line before cutting off the crimped portion and splicing in a new piece of pipe. However, it can be appreciated that such freezing equipment is quite sophisticated and expensive to acquire and maintain. Further, the equipment now available for freezing pipes in the field requires a source of electricity to operate which means that, in the field, an electrical generator is also needed and the whole process is considerably time consuming.

Accordingly it is desirable to provide a method and apparatus for stopping the flow of a fluid, such as pressurized water in a damaged pipe, temporarily while a repair is made, without resulting in restricting the flow or weakening the wall of the pipe after the repair is completed. It is further desirable to provide such a method and apparatus which does not involve the use of expensive equipment that is time consuming to use.

### SUMMARY OF THE INVENTION

The present invention offers a considerable improvement over the prior art by providing a method and apparatus for temporarily stopping the flow of fluid issuing from a live pipe including a plug device which can be manually inserted into the flowing pipe to stop the flow of fluid temporarily while the pipe is repaired. The plug is advantageously designed to remain in the pipe and dissolve after a predetermined period of time under action of the particular fluid in the pipe. The plug is also capable of being installed quickly and is manufacturable by readily available and inexpensive methods.

### BRIEF DESCRIPTION OF THE DRAWINGS

The foregoing and other novel features and advantages of the invention will become apparent upon a reading of the following detailed description taken in conjunction with the accompanying drawings, wherein:

FIG. 1 is an end view, looking forwardly, of a plug constructed in accordance with the principles of the invention;

FIG. 2 is a side cross-sectional view of a first embodiment taken substantially along the line 2-2 of FIG. 1;

FIG. 3 is a side cross-sectional view of another embodiment of the invention; and

FIG. 4 is a front view of yet another embodiment of the invention.

### DETAILED DESCRIPTION OF THE PREFERRED EMBODIMENTS

Referring now to the drawings, and initially to FIG. 1, a plug in accordance with the invention is shown in end view and designated generally by the reference numeral 10. The plug 10 is seen in this view as looking forwardly along its longitudinal axis and includes as its principal components a circular stem portion 12 and one or more disk portions 14, only one of which can be seen in FIG. 1.

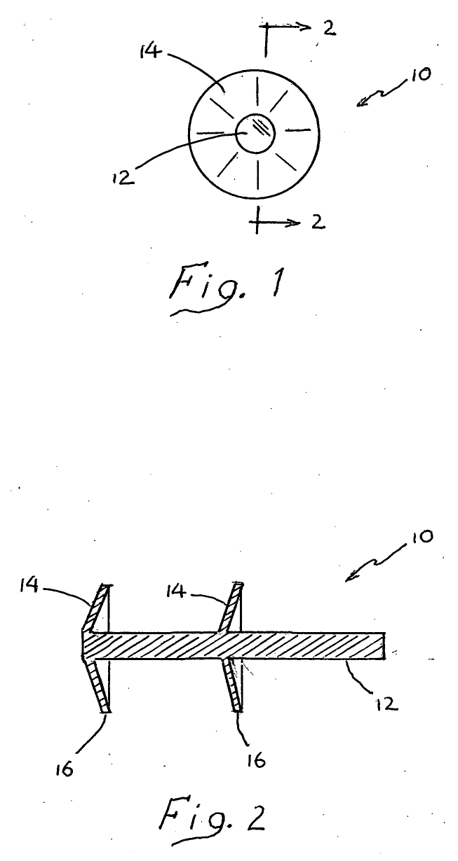

Turning to FIG. 2, the plug of FIG. 1 is shown in side cross-section wherein the stem portion 12 can be seen as a generally elongate member integrally formed with a pair of disk portions 14. The disk portions 14 are preferably configured to angle back, rearwardly of the plug 10 to facilitate centering of the plug 10 during its insertion into a pipe (not shown). The disk portions 14 preferably have an outside diameter slightly larger than the inside diameter of the particular pipe to be plugged and are designed to flex rearwardly of the plug 10 upon its insertion into a pipe while forming a fluid-tight seal with the inside wall of the pipe when insertion of the plug 10 is completed. The surfaces 16 of the outer circumferences of the disk portion are shown flat. However, they can also be rounded or angled as needed, or desired in manufacture, while still capable of forming a tight seal with the pipe.

FIG. 3 shows a plug 20 which is an alternative embodiment of plug 10 and similar to plug 10 is designed with a suitable elongate stem portion 22 and a pair of disk portions 24. However, in this embodiment the plug 20 includes a forwardly open hemispherical portion 26 integrally formed with the stem portion 22. This hemispherical portion 26 advantageously serves as a deflector to deflect fluid issuing from a pipe forwardly of the plug 20 as it is inserted into the pipe. Thus, the possibility of the issuing fluid spraying the individual inserting the plug into the pipe is minimized.

Having described the foregoing embodiments 10 and 20 of the plug, it is an important aspect of the invention to consider a preferred material from which the plugs 10 and 20 can be made. In one form, the plugs 10 and 20 are preferably injection molded of simple gelatin or a composition thereof. Gelatin in a dry, room temperature rigid state has the capability of being machinable and very hard, while still retaining a degree of resilience and resistance to breakage or cracking under stress. It is also non-harmful to humans when ingested orally and in fact is used by humans as a dietary supplement. One only needs to examine a typical medicine capsule made of gelatin to appreciate that gelatin can be made into a structural member to close manufacturing tolerances in dry form, and yet is readily dissolvable in water. Thus it is an ideal material to use in fabricating the plugs 10 and 20 previously described particularly where the pipe intended to be plugged is carrying water. Once a gelatinaceous plug 10 or 20 is inserted into a live or leaking water pipe, a repair to the pipe can be made with the plug 10 or 20 in place and, in time, the plug will completely dissolve under its contact with the water in the pipe.

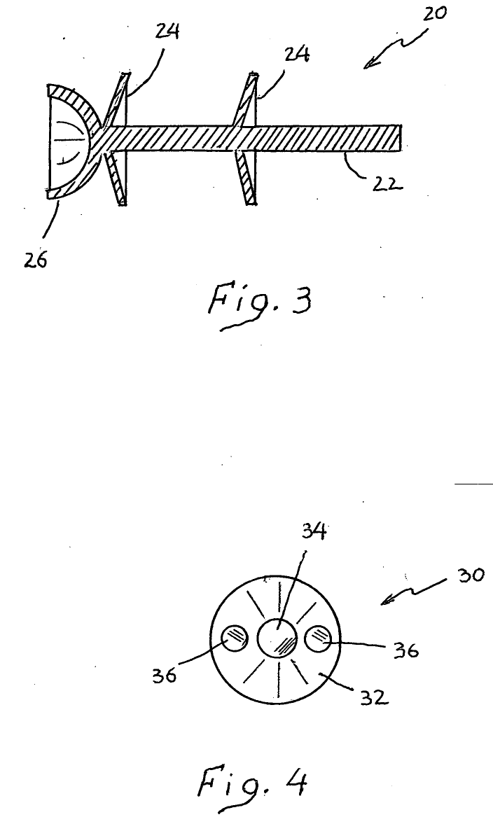

FIG. 4 shows yet another embodiment of the invention illustrating a plug 30 constructed much like the plugs 10 and 20 of FIGS. 1-3. However, in this embodiment a disk portion 32 connected to a stem portion 34 is constructed with one or more areas 36 of reduced wall thickness formed as by molding or machining into the disk portion 32. The advantage of these reduced wall thickness areas 36 is that the wall thickness of the areas 36 can be readily selected in a gelatin-formed plug to dissolve at any desired predetermined time after plug insertion into a live water pipe. Once the areas 36 dissolve through, the pipe will begin flowing again and the remainder of the plug will also quickly dissolve.

It can now be appreciated that a plug constructed in accordance with the invention offers considerable advantages over prior art methods and devices for temporarily sealing a fluid-carrying pipe. Particularly where a damaged copper water line is involved, for example, a worker in the field can simply crimp an end of the pipe closed while he or she uses a tubing cutter to create a clean end to the pipe, then quickly and easily insert the plug into the repaired pipe end by tapping the stem of the plug with a hammer. Once the pipe is plugged a repair can readily be made to the pipe using a section of new pipe or sweating on an appropriate coupling or valve for example. The release of the plug may also be accelerated by heating the pipe at the plug with a torch if desired once the repair is complete. Otherwise the plug will dissolve, in time, naturally. The invention offers considerable advantages to plumbers who may have the ability to shut down the pressure in a water line, but must wait until the whole related water system drains down before the pipe can be heated sufficiently to sweat a new joint. Although gelatin has been selected as a preferred material for the invention because of its moldability, and resilience in cured form, it can be appreciated that other materials that are non-harmful to humans may be possible for practicing the invention, such as compositions of salt, sugar or flour. Also, although a plug with two disk portions has been illustrated herein, any number of disk portions may be used as desired to properly seal a pipe. Moreover, the plug of the instant invention can also be capable of temporarily stopping the flow of such fluids as liquid petroleum products, naphtha, or natural gas, for example, if a suitable material for the plug is selected.

While the invention has been described in connection with certain preferred embodiments it will be understood by those skilled in the art that many changes and modifications may be made without departing from the true spirit and scope of the invention. Accordingly, it is intended by the appended claims to cover all such changes and modifications as come within the spirit and scope of the invention.

I claim:

1. A device for stopping the flow of a fluid issuing from a pipe comprising:
a stem portion;
at least one circular disk portion centered on and extending at right angles to the stem portion, the disk portion being dimensioned and configured to form a fluid tight seal with the inside wall of a pipe when inserted in an open end of the pipe;
wherein the entire device is formed as a substantially rigid structure from a material which is dissolvable in time by fluid contained in the pipe.

2. The device of claim 1 wherein the stem portion and disk portion are moldable as a unitary assembly.

3. The device of claim 1 wherein the stem portion is dimensioned and configured to allow the device to be driven as by a hammer into the open end of a pipe.

4. The device of claim 1 including a multiplicity of circular disk portions each spaced from each other along the stem portion.

5. The device of claim 1 wherein the entire device is formed of a gelatinaceous material.

6. The device of claim 1 wherein the disk portion is formed with a discrete area of reduced wall thickness such that such area dissolves more quickly than other areas of the disk portion.

7. The device of claim 1 wherein the disk portion is shaped with a rearwardly directed angle to facilitate its insertion into a pipe.

8. The device of claim 1 including means disposed ahead of the at least one disk portion and configured to deflect fluid issuing from a pipe in a direction generally forwardly of the device as the device is inserted into the pipe.

9. A method of temporarily stopping the flow of a fluid issuing from a pipe, comprising the steps of:
providing a device having a stem portion with at least one circular disk portion centered on and extending at right angles to the stem portion;
the disk portion being dimensioned and configured to form a fluid-tight seal with an interior wall of the pipe;
the device being made of a substantially rigid material that is dissolvable in time by a fluid in the pipe; and
inserting the device into an open end of the pipe thereby temporarily substantially stopping the flow of fluid issuing from the pipe.

10. The method according to claim 9 including the step of applying force to the stem portion to facilitate insertion of the device into a pipe.

11. The method according to claim 10 wherein the force is applied as by use of a hammer.

12. The method according to claim 9 including providing the device with a multiplicity of disk portions extending from the stem portion.

13. The method according to claim 9 wherein the device is made entirely of a gelatinaceous material.

14. The method according to claim 9 wherein the device is formed as a unitary member.

15. A device for temporarily stopping the flow of a live fluid-carrying pipe comprising:
a generally circular disk member dimensioned and configured to form a fluid tight seal with the inside wall of a pipe when inserted in the pipe;
means for inserting the disk member into a flowing pipe;
wherein the disk member is dissolvable, in time, by the fluid contained in the pipe.

16. The device of claim 15 wherein the disk member is composed of a gelatinaceous material and the fluid in the pipe is substantially water.

17. The device of claim 15 wherein the means for inserting the disk member is a stem member.

18. The device of claim 17 wherein the stem member is integrally formed with the disk member.

19. The device of claim 15 including a plurality of disk members.

20. The device of claim 15 wherein the disk member and the means for inserting the disk member are both dissolvable, in time, by the fluid flowing in the pipe.
